(19) United States
(12) Patent Application Publication
(10) Pub. No.: US 2015/0100287 A1
(43) Pub. Date: Apr. 9, 2015

(54) METHOD FOR SIMULATING THE SELF-ASSEMBLY OF BLOCK COPOLYMERS IN ORDER TO DESIGN A PRINTED CIRCUIT, CORRESPONDING DESIGN METHOD, DESIGN SYSTEM AND COMPUTER PROGRAM

(71) Applicant: COMMISSARIAT A L'ENERGIE ATOMIQUE ET AUX ENE ALT, Paris (FR)

(72) Inventor: Jerome Belledent, Meylan (FR)

(73) Assignee: COMMISSARIAT A L'ENERGIE ATOMIQUE ET AUX ENE ALT, Paris (FR)

(21) Appl. No.: 14/390,679

(22) PCT Filed: Apr. 4, 2013
(86) PCT No.: PCT/FR2013/050746

§ 371 Date: Oct. 3, 2014

(30) Foreign Application Priority Data
Apr. 5, 2012 (FR) 1253161

(51) Int. Cl. G06F 17/50; G06F 19/00

(52) U.S. Cl. CPC G06F 17/5009; G06F 19/702
USPC 703/2; 703/6

(57) ABSTRACT

A method for simulating a placement of patterns by self-assembly of block copolymers in a contour printed on a plate by lithography includes: extraction of geometric parameters of the contour recorded in a memory; selection, by a processor having access to the memory, of at least one local extremum of an interference figure produced inside the contour on the basis of the geometric parameters of the contour by applying a model for propagation of waves interfering with one another; and provision, by the processor and on the basis of the local extremum, of parameters for placement of at least one pattern intended to be obtained by self-assembly of block copolymers within the contour.

This invention relates to a method for simulating a placement of patterns by self-assembly of block copolymers within a contour printed on a plate by lithography. It also relates to a method for designing a printed circuit using this simulation method. Finally, it also relates to a corresponding design system and computer program.

The placement of patterns, such as conductive lines, contacts or pillars, by self-assembly of block copolymers within a contour previously printed by a lithography technique is a recent technique for designing electronic printed circuits, for example described in the article of Sanders et al, entitled “Integration of directed self-assembly with 193 nm lithography”, Journal of Photopolymer Science and Technology, vol. 23, N^{o} 1 (2010), pages 11-18.

This technique consists, in a first stage, in printing a first pattern on a plate by a known lithography technique, for example photolithography, electron-beam lithography, or another technique, the first pattern obtained including at least one printed contour within which smaller patterns, for example of nanometric dimensions, are intended to be placed. On this nanometric scale, and in a second stage, the placement of the smaller patterns is performed by self-assembly of block copolymers inserted within the contour. The patterns obtained are dependent upon molecular ratios chosen for the copolymers and the molecular portion suppressed after the placement has been performed. Thus, by means of copolymers with two blocks A and B of different types and linked to one another by a covalent bond, it is possible, depending on the chosen ratios, to obtain lines, contacts, pillars, trenches or the like.

This technique thus makes it possible to obtain nanometric resolutions opening up possibilities for miniaturization of microelectronic components.

However, this technique must be implemented extremely carefully in order to spatially control the positioning of the patterns with precision, in order to respond to design needs or to respect an alignment between different circuit levels. Whether regarding the contours or the smaller patterns within the contours, patterns on plates are subject to classic distortions caused by a lack of resolution, variations in doses, focus, effects in the resin, and so on.

This is why it is advantageous to be capable of performing a simulation of placements of patterns by self-assembly of block copolymers within contours printed on a plate by lithography, as a complement to an optical proximity correction or OPC. This indeed makes it possible to anticipate the distortions (main objective of an OPC), then refine this anticipation by simulating pattern placements.

There are, in particular, proposals to simulate physicochemical effects involved in the self-assembly of block copolymers. In this way, it may be envisaged to simulate the placement of patterns on the basis of such a simulation of physicochemical effects. However, this approach is very complex and costly in terms of calculation time. It can therefore be applied only to very small copolymer volumes.

It may thus be desirable to provide a simulation method of the type mentioned above that makes it possible to overcome at least some of the problems and constraints mentioned above.

A method is therefore proposed for simulating a placement of patterns by self-assembly of block copolymers within a contour printed on a plate by lithography, including the following steps:
extraction of geometric parameters of the contour recorded in a memory,
selection, by a processor having access to the memory, of at least one local extremum of an interference figure produced inside the contour on the basis of the geometric parameters of the contour by applying a model for propagation of waves interfering with one another,
provision, by the processor and on the basis of said local extremum, of parameters for placing at least one pattern intended to be obtained by self-assembly of block copolymers within the contour.

It was indeed observed, surprisingly, that a propagation model in principle not having any correlation with the physicochemical phenomena involved in the placement of patterns by self-assembly of block copolymers within given contours, is, in the end, particularly suitable for anticipating the placement of said patterns, which can be located on the basis of the local extrema of interference figures produced by said propagation model. As the interference between waves propagating according to a given model are, furthermore, simple to calculate at all points, the result is an estimation of the placement of patterns by self-assembly of block copolymers, which is both precise and simple to calculate.

Optionally:
the geometric parameters of the contour are points of said contour,
the selection step includes the application of a first model for propagation of waves emitted from said points, producing an interference figure inside the contour, and the selection of at least one local maximum of the imaginary part of said interference figure.

Also optionally, the interference figure produced by the first model, denoted I₀(M) at any one point M located inside the contour, is defined by the following expression:

$${I}_{0} ( M ) = {\sum }_{i = 0}^{n - 1} f ( ‖ \vec{{p}_{i} M} ‖ ) {e}^{\frac{2 i π ( ‖ \vec{{p}_{i} M} ‖ - {d}_{1} )}{{pn}_{0}}} ,$$

where f is an attenuation function defined as follows:

$$f ( r ) = \{ \begin{matrix}1 & if r \leq {d}_{1} \\ {e}^{- \frac{{( r - {d}_{1} )}^{2}}{2 {d}_{2}^{2}}} & if r > {d}_{1}^{′}\end{matrix} ,$$

and where {pₜ,0≦i<n} is a set of points of the contour forming its geometric parameters, parameter d₁ is a constant parameter, for example chosen to be close to half of a natural pitch of said block copolymers, said natural pitch representing a natural distance between block copolymers at energy equilibrium, and parameter d₂ is a constant parameter, for example chosen to be close to said natural pitch.

Also optionally, parameters d₁ and d₂ are defined on the basis of a calibration of said propagation model on several patterns.

Also optionally, the selection step further comprises, after application of said first propagation model and the selection of at least one local maximum of the imaginary part of the interference figure produced by said first model, a loop of steps comprising the application of a new wave propagation model, each iteration of said loop of steps comprising:
the application of the new model by wave emission on the basis of at least one local maximum selected in the previous iteration or on the basis of said at least one local maximum selected by applying the first model if it is the first iteration, producing a new interference figure inside the contour,
the selection of at least one local maximum of the imaginary part of said new interference figure.

Also optionally, the new interference figure, denoted Iⱼ(M) at any point M located inside the contour and at the j-th iteration of the loop of steps, is defined by the following expression:

$${I}_{j} ( M ) = {I}_{0} ( M ) + {C}_{0} {\sum }_{E ∈ {E}_{j - 1}} g ( ‖ \vec{EM} ‖ ) {e}^{\frac{2 i π ( ‖ \vec{EM} ‖ - 0.75 {pn}_{0} )}{{pn}_{0}}} ,$$

where the attenuation function g is defined as follows:

$$g ( r ) = \{ \begin{matrix}1 if r \leq {pn}_{0} \\ {e}^{- \frac{{( r - {pn}_{0} )}^{2}}{2 {d}_{2}^{2}}} \cdot ( 1 - {e}^{- \frac{9 {r}^{2}}{2 {pn}_{0}^{2}}} ) if r > {pn}_{0}\end{matrix} ,$$

and where C₀ is a constant parameter, for example chosen to be close to 1, and Eⱼ₋₁, is the set of local maxima selected in the previous iteration or by applying the first model if it is the first iteration.

Also optionally, parameter C₀ is defined on the basis of a calibration of said propagation model on several patterns.

Also optionally, the selection step is stopped when the number of local extrema selected reaches an expected number of patterns to be placed within the contour by self-assembly of block copolymers, this expected number being, for example, defined as being the ratio between the interior surface of the contour and a known natural mean space, occupied by each of said patterns in an environment without contour constraints, for their placement by self-assembly of block copolymers.

A method for designing a printed circuit is also proposed, which is intended to include at least one contour printed on a plate by lithography, at least one pattern having to be placed by self-assembly of block copolymers within said contour, including the following steps:
recording in a memory of geometric parameters of a plurality of contours of different shapes,
execution of the steps of a simulation method as defined above for each of said contours, and
selection of a contour on the basis of the placement parameters provided for each of said contours, on the basis of a predefined desired placement of at least one pattern in the printed circuit.

Optionally, a method for designing a printed circuit according to the invention may further include the following steps:
printing of the selected contour on a plate of the printed circuit by photolithography, and
insertion and self-assembly of block copolymers within said printed contour.

A computer program is also proposed, which computer program is downloadable from a communication network and/or recorded on a computer-readable medium and/or executable by a processor, characterized in that it includes instructions for executing the steps of a simulation method or for executing the steps of a design method as defined above, when said program is executed on a computer.

Finally, a system for designing a printed circuit is also proposed, which includes:
a memory for storing geometric parameters of a plurality of contours of different shapes,
a simulator programmed to implement a simulation method as defined above for each of said contours, and
a contour selector for selecting a contour on the basis of placement parameters provided for each of said contours, according to a predefined desired placement of at least one pattern in the printed circuit.

The invention will be easier to understand in view of the following description, provided solely as an example, and with reference to the appended drawings, wherein:

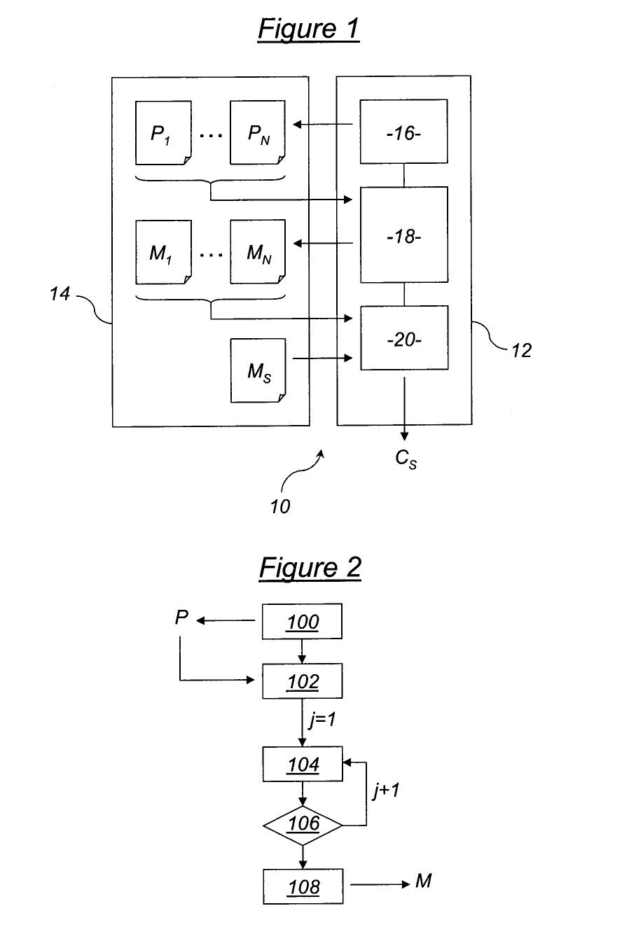

FIG. 1 schematically shows the general structure of a system for designing a printed circuit, according to an embodiment of the invention,

FIG. 2 shows the successive steps of a simulation method implemented by the design system of FIG. 1,

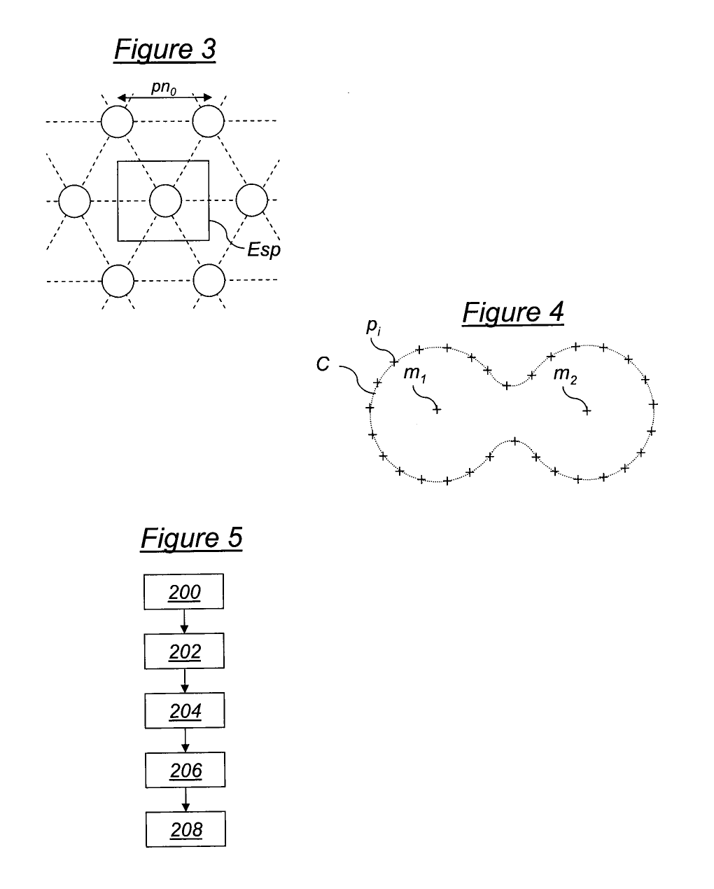

FIG. 3 shows a natural positioning of block copolymers for a theoretical vertical cylindrical arrangement without contour constraints,

FIG. 4 shows the result of an execution of the simulation method of FIG. 2 on a given contour, and

FIG. 5 shows the successive steps of a method for designing a printed circuit, according to an embodiment of the invention.

The system 10 for designing a printed circuit schematically shown in FIG. 1 includes a processing module 12 conventionally associated with a memory 14 (for example, a RAM memory). It may, for example, be implemented in a computing device such as a conventional computer comprising a processor associated with one or more memories for the storage of data files and computer programs. The processing module 12 can itself then be considered to be formed by a processor associated with a memory for storing instructions that it executes in the form of computer programs.

The processing module 12 as shown in FIG. 1 thus functionally includes three computer programs 16, 18 and 20.

The first computer program 16 is a program for generating and recording geometric contour parameters. From a contour C to be printed on a plate, for example defined and corrected by OPC, it is designed to provide a set P of geometric parameters P of said contour C in the form of a digital file. In the embodiment described below, these parameters are points pᵢ of the contour C distributed as regularly as possible along said contour.

The contour C itself may be provided in the form of a digital image resulting from a simulation, an observation under scanning electron microscope, etc.

The set P={pᵢ,0≦i<n} is, for example, a set of points belonging to C such as:

∀iε{1, . . . ,n−1}, D(\vec{pᵢ₋₁pᵢ})=d₀,

∀iε{1, . . . ,n−2}, D(\vec{pᵢ₋₁pᵢ₊₁})=d₀,

and

D(\vec{pₙ₋₁p₁})≦d₀,

where D designates the curvilinear distance along the contour C and d₀ is a positive parameter, the real value of which is close to one-quarter of the natural pitch pn₀ separating the microphases generated by the copolymers considered on a free surface, the natural pitch pn₀ representing the natural distance between the block copolymers considered at energy equilibrium.

The first condition requires a regular distribution of points pᵢ along the contour C. The second condition proposes a direction of the set P of points pᵢ along the contour C. Finally, the third condition defines the relative positions of the first and last points of the set P within the contour C, which is closed.

Thus, on the basis of a plurality of contours C₁, . . . , C_{N} of different shapes, the first computer program 16 provides a plurality of sets P₁, . . . , P_{N} of respective geometric parameters of these contours in the form of digital files. These digital files P₁, . . . , P_{N} are then stored in the memory 14.

The second computer program 18 is a simulator programmed to implement a simulation method that will be described in reference to FIG. 2. From each file Pᵢ, it provides a set Mᵢ of parameters for placing patterns within the contour C₁ considered, this placement of patterns corresponding, by the efficacy of the simulation, to that of a self-assembly of block copolymers within the contour Cᵢ considered when the latter is printed on a plate by lithography.

Thus, on the basis of the plurality of sets P₁, . . . , P_{N} of geometric parameters, the second computer program 18 provides a plurality of sets M₁, . . . , M_{N} of respective parameters for the placement of patterns within the contours C₁, . . . , C_{N} in the form of digital files. These digital files M₁, . . . , M_{N} are then stored in the memory 14. The pattern placement parameters are, for example, the coordinates of the centers of patterns placed by self-assembly of block copolymers.

The third computer program 20 is a contour selector for selecting a contour on the basis of the plurality of sets M₁, . . . , M_{N} of pattern placement parameters provided for each of the contours C₁, . . . , C_{N}, on the basis of a predefined desired placement of at least one pattern in the printed circuit to be designed. This desired placement is, for example, predefined in the form of a file M_{S} of parameters defined in the same way as those of files M₁, . . . , M_{N}. By a simple comparison of the parameters of file M_{S} with the parameters of files M₁, . . . , M_{N}, by means of any one distance criterion, for example, one of said files M₁, . . . , M_{N} is selected and the corresponding contour as well. The latter is denoted C_{S} in FIG. 1.

It is also noted that the computer programs 16, 18, 20 are presented as being distinct, but this distinction is purely functional. They may also be grouped together in one or more software programs. Their functions may also be at least partially micro-programmed or micro-wired in dedicated integrated circuits. Thus, alternatively, the computing device implementing the design system 10 may be replaced by an electronic device comprised solely of digital circuits (without a computer program) for performing the same actions.

The simulation method shown in FIG. 2 and implemented by the simulator 18 comprises a first step 100 of extracting a set P={pᵢ,0≦i<n} of geometric parameters of a contour C recorded in the memory 14. The reference P thus designates any one of the files P₁, . . . , P_{N} mentioned above.

In a second step 102, the simulator 18 of the processing module 12 provides a first interference figure I₀ produced inside A of the contour C by simulating a propagation of waves interfering with one another starting from points pᵢ of contour C, which are considered to be emission points of said waves.

A propagation model providing good results is indicated as an example below. This model is defined so that, at any point M located inside A of the closed contour C, the first interference figure I₀ has the following value:

$${I}_{0} ( M ) = {\sum }_{i = 0}^{n - 1} f ( ‖ \vec{{p}_{i} M} ‖ ) {e}^{\frac{2 i π ( ‖ \vec{{p}_{i} M} ‖ - {d}_{1} )}{{pn}_{0}}} ,$$

where the attenuation function f is defined as follows:

$$f ( r ) = \{ \begin{matrix}1 if r \leq {d}_{1} \\ {e}^{- \frac{{( r - {d}_{1} )}^{2}}{2 {d}_{2}^{2}}} if r > {d}_{1}\end{matrix} .$$

In these two expressions, the parameter d₁ can be chosen to be equal to half of the natural pitch pn₀ and parameter d₂ equal to pn₀. It is also possible to calibrate these parameters on the basis of the results obtained for several basic structures. It is thus noted that the propagation model chosen requires a zero phase at any point of A located at the distance

$$\frac{{pn}_{0}}{2}$$

from the contour C and an attenuation toward the inside of the contour C that begins at this same distance

$$\frac{{pn}_{0}}{2}$$

from the contour C.

During this same step 102, at least one local extremum of the first interference figure in the interior A of the contour C, in this case a local maximum, is selected. Let E₀ be the set of local extrema of I₀. The criterion for selection, and therefore for constitution of the set E₀ is, for example, as follows:

E₀={M∈A|∃ε∈ [symbol] ⁺*|∀M′∈A, 0<∥\vec{MM′}∥<ε [symbol] Im(I₀(M))>Im(I₀(M′))},

where
Im is the function giving the imaginary part of any complex number. E₀ is therefore the set of points of A for which a local extremum of the imaginary part of I₀ is obtained.

Step 102 is followed by a loop of steps 104, 106 repeated for as many times as a stopping criterion CA has not been satisfied. The stopping criterion is, for example, the expected number of patterns within the contour C by self-assembly of block copolymers. To illustrate this stopping criterion CA in the specific case of patterns such as contacts or pillars, a natural positioning of block copolymers is shown in FIG. 3 for a theoretical vertical cylindrical arrangement without contour constraints. According to this arrangement, each contact or pillar is distant from the others by a distance equal to the natural pitch pn₀, which gives a regular hexagonal structure wherein each contact or pillar occupies a natural mean space Esp of

$${pn}_{0} \cdot \frac{\sqrt{3} {pn}_{0}}{2} ,$$

that is

$$\frac{\sqrt{3} {pn}_{0}^{2}}{2} .$$

It can be assumed that the space occupied by each pattern within the contour C must be as close as possible to this natural mean space. Thus, the stopping criterion CA can be given by the following formula:

$$CA = E ( A / ( \frac{\sqrt{3} {pn}_{0}^{2}}{2} ) ) = E ( \frac{2 A}{\sqrt{3} {pn}_{0}^{2}} ) ,$$

where E is the round-off function returning the nearest integer.

An execution of the loop of steps 104, 106 is identified by an index j≧1. In a j-th execution of step 104, the simulator 18 of the processing module 12 provides a new interference figure Iⱼ produced inside A of the contour C by simulating a propagation of waves interfering with one another starting from points of the set Eⱼ₋₁, which are considered to be emission points of said waves.

A new propagation model providing good results for the loop of steps 104, 106 is indicated as an example below. This model is defined so that at any point M located inside A of the contour C, the new interference Iⱼ takes the following value:

$${I}_{j} ( M ) = {I}_{0} ( M ) + {C}_{0} {\sum }_{E ∈ {E}_{j - 1}} g ( ‖ \vec{EM} ‖ ) {e}^{\frac{2 i π ( ‖ \vec{EM} ‖ - 0.75 {pn}_{0} )}{{pn}_{0}}} ,$$

where the attenuation function g is defined as follows:

$$g ( r ) = \{ \begin{matrix}1 if r \leq {pn}_{0} \\ {e}^{- \frac{{( r - {pn}_{0} )}^{2}}{2 {d}_{2}^{2}}} \cdot ( 1 - {e}^{- \frac{9 {r}^{2}}{2 {pn}_{0}^{2}}} ) if r > {pn}_{0}\end{matrix} .$$

In these expressions, the parameter C₀ is chosen, for example, to be close to 1. It may also be defined on the basis of a preliminary calibration of the model, such as parameters d₁ and d₂.

During this same step 104, at least one local extremum of the new interference figure Iⱼ in the inside A of contour C, in this case a local maximum, is selected. Eⱼ then denotes the set of local extrema of The criterion for selection, and therefore for constitution of the set Eᵢ is, for example, as follows:

Ej={M∈A|∃ε∈ [symbol] ⁺*|∀M′∈A and 0<∥\vec{MM′}∥<ε [symbol] Im(Iⱼ(M))>Im(Iⱼ(M′))}.

In the next test step 106, the number of points in the set E; is compared with CA. Insofar as the number CA is not obtained, j is incremented by one unit and the method returns to step 104 for a new iteration of the loop of steps 104, 106.

If CA is obtained, a final end-of-simulation step 108 is performed, wherein the set M of parameters for placing patterns within the contour C is provided. More specifically, M=Eⱼ. In other words, it is considered that the placement of patterns intended to be obtained by self-assembly of block copolymers within the contour C is performed on the local extrema of the last interference figure calculated.

FIG. 4 shows the result of an execution of the simulation method of FIG. 2 on a simple contour C, inside of which two patterns may a priori be placed by self-assembly of block copolymers. The set P is constituted by points pᵢ distributed along the contour C. The set M provided at the end of the simulation comprises two patterns centered at two points m₁ and m₂.

The method shown in FIG. 5 is a method for designing a printed circuit intended to comprise at least one contour printed on a plate by lithography, at least one pattern having to be placed by self-assembly of block copolymers within said contour.

It comprises a first step 200 of recording, in the memory 14, the geometric parameters of a plurality of contours C₁, . . . , C_{N} of different shapes. This first step 200 is performed by executing the first computer program 16 and provides the plurality of sets P₁, . . . , P_{N} of respective geometric parameters of the contours C₁, . . . , C_{N}.

It then comprises a step 202 of executing steps 100 to 108 of the simulation method described above for each of the contours C₁, . . . , C_{N}. This step 202 is performed by executing the second computer program 18 and provides the plurality of sets M₁, . . . , M_{N} of pattern placement parameters.

It then comprises a step 204 of selecting a contour C_{S} executed by the third computer program 20, the operation of which has already been described.

It then comprises a step 206 of actual printing of the selected contour on a plate of the printed circuit by photolithography. This step will not be described because it is well known.

Finally, it comprises a step 208 of insertion and self-assembly of block copolymers within the printed contour in order to place the desired pattern(s). This step will not be described either because it is also well known.

It clearly appears that a design system, a simulation method and a design method as described above make it possible to facilitate the production of printed circuits wherein patterns are formed by self-assembly of block copolymers within contours printed on a plate by lithography. By proposing a pattern placement model that is original and easy to simulate, the production performance is indeed improved.

It should also be noted that the invention is not limited to the embodiments described above.

In particular, the parameters C₀, d₁ and d_{z} of the propagation models presented may take values different from those chosen. They may advantageously be defined on the basis of a knowledge acquisition on several patterns. A person skilled in the art will be able to adapt them to the context. Similarly, the propagation models can be chosen differently, also according to the context.

In particular as well, if an iterative approach is chosen to estimate an interference figure inside a given contour as described above, the stopping criterion may be different from that proposed. Alternatively, it is possible, for example, to determine, in advance, the number of iterations. In general, five iterations at most suffice. Moreover, the stopping criterion may be reached, therefore tested, upon execution of step 102, without requiring the loop of steps 104, 106 to be executed.

It will more generally be clear to a person skilled in the art that various modifications may be made to the embodiments described above, in light of the teaching disclosed above. In the claims below, the terms used must not be interpreted as limiting the claims to the embodiments disclosed in the present description, but must be interpreted as including all of the equivalents that the claims are intended to cover by means of their wording, and that can be carried out by a person skilled in the art applying general knowledge to the teaching disclosed above.

1-12. (canceled)

13. A method for simulating a placement of patterns by self-assembly of block copolymers within a contour printed on a plate by lithography, the method comprising:
extraction of geometric parameters of the contour recorded in a memory;
selection, by a processor having access to the memory, of at least one local extremum of an interference figure produced inside the contour on the basis of the geometric parameters of the contour by applying a model for propagation of waves interfering with one another;
provision, by the processor and on the basis of the local extremum, of parameters for placing at least one pattern intended to be obtained by self-assembly of block copolymers within the contour.

14. The simulation method as claimed in claim 13, wherein:
the geometric parameters of the contour are points of the contour;
the selection includes application of a first model for propagation of waves transmitted from the points, producing an interference figure inside the contour, and selection of at least one local maximum of the imaginary part of the interference figure.

15. The simulation method as claimed in claim 14, wherein the interference figure produced by the first model, denoted I₀(M) at any point M located inside the contour, is defined by the following expression:
$${I}_{0} ( M ) = {\sum }_{i = 0}^{n - 1} f ( ‖ \vec{{p}_{i} M} ‖ ) {e}^{\frac{2 i π ( ‖ \vec{{p}_{i} M} ‖ - {d}_{1} )}{{pn}_{0}}} ,$$
where f is an attenuation function defined as follows:
$$f ( r ) = \{ \begin{matrix}1 if r \leq {d}_{1} \\ {e}^{- \frac{{( r - {d}_{1} )}^{2}}{2 {d}_{2}^{2}}} if r > {d}_{1}\end{matrix} ,$$
and where {pᵢ,0≦i<n} is a set of points of the contour forming its geometric parameters, parameter d₁ is a constant parameter, or chosen to be close to half of a natural pitch of the block copolymers, the natural pitch representing a natural distance between block copolymers at energy equilibrium, and parameter d₂ is a constant parameter, or chosen to be close to the natural pitch.

16. The simulation method as claimed in claim 15, wherein parameters d₁ and d₂ are defined on the basis of a calibration of the propagation model on plural patterns.

17. The simulation method as claimed in claim 14, wherein the selection further comprises, following application of the first propagation model and selection of at least one local maximum of the imaginary part of the interference figure produced by the first model, a loop of operation comprising application of a new wave propagation model, each iteration of the loop comprising:
application of the new model by wave emissions from at least one local maximum selected in a previous iteration or from the at least one local maximum selected by applying the first model if it is the first iteration, producing a new interference figure inside the contour;
selection of at least one local maximum of the imaginary part of the new interference figure.

18. The simulation method as claimed in claim 17, wherein the new interference figure, denoted Iⱼ(M) at any one point M located inside the contour and at the j-th iteration of the loop of operation, is defined by the following expression:
$${I}_{j} ( M ) = {I}_{0} ( M ) + {C}_{0} {\sum }_{E ∈ {E}_{j - 1}} g ( ‖ \vec{EM} ‖ ) {e}^{\frac{2 i π ( ‖ \vec{EM} ‖ - 0.75 {pn}_{0} )}{{pn}_{0}}} ,$$
where the attenuation function g is defined as follows:
$$g ( r ) = \{ \begin{matrix}1 if r \leq {pn}_{0} \\ {e}^{- \frac{{( r - {pn}_{0} )}^{2}}{2 {d}_{2}^{2}}} \cdot ( 1 - {e}^{- \frac{9 {r}^{2}}{2 {pn}_{0}^{2}}} ) if r > {pn}_{0}\end{matrix} ,$$
and where C₀ is a constant parameter, for example chosen to be close to 1, and Eⱼ₋₁ is the set of local maxima selected in the previous iteration or by applying the first model if it is the first iteration.

19. The simulation method as claimed in claim 18, wherein the parameter C₀ is defined on the basis of a calibration of the propagation model on plural patterns.

20. The simulation method as claimed in claim 13, wherein the selection is stopped once a number of local extrema selected reaches an expected number of patterns to be placed within the contour by self-assembly of block copolymers, or the expected number is defined as a ratio between an interior surface of the contour and a known natural mean space, occupied by each of the patterns in an environment without contour constraints, for their placement by self-assembly of block copolymers.

21. A method for designing a printed circuit configured to include at least one contour printed on a plate by lithography, at least one pattern having to be placed by self-assembly of block copolymers within the contour, the method comprising:
recording in a memory of geometric parameters a plurality of contours of different shapes;
execution of a simulation method as claimed in claim 13 for each of the contours; and
selection of a contour on the basis of the placement parameters provided for each of the contours, on the basis of a predefined desired placement of at least one pattern in the printed circuit.

22. The method for designing a printed circuit as claimed in claim 21, further comprising:
printing the selected contour on a plate of the printed circuit by photolithography; and
insertion and self-assembly of block copolymers within the printed contour.

23. A non-transitory computer readable medium including a computer program comprising instructions for executing the method as claimed in claim 13, when executed on a computer.

24. A system for designing a printed circuit, comprising:
a memory for storing geometric parameters of a plurality of contours of different shapes;
a simulator programmed for implementing a simulation method as claimed in claim 13 for each of the contours; and
a contour selector for selecting a contour on the basis of the placement parameters provided for each of the contours, on the basis of a predefined desired placement of at least one pattern in the printed circuit.
